(19) United States
(12) Patent Application Publication
(10) Pub. No.: US 2013/0153483 A1
(43) Pub. Date: Jun. 20, 2013

(54) PHOTOCATALYTIC COMPOSITE MATERIAL

(71) Applicants: Franca MORAZZONI, Milano (IT); Roberto Scotti, Bergamo (IT); Maurizio Crippa, Pavia (IT); Massimiliano D'Arienzo, Monza e Brianza (IT)

(72) Inventors: Franca MORAZZONI, Milano (IT); Roberto Scotti, Bergamo (IT); Maurizio Crippa, Pavia (IT); Massimiliano D'Arienzo, Monza e Brianza (IT)

(21) Appl. No.: 13/328,360

(22) Filed: Dec. 16, 2011

(51) Int. Cl. B01J 21/06; B01J 19/12; C02F 1/32; B01J 21/08; B01J 21/04; B82Y 30/00

(52) U.S. Cl. 210/263; 502/350; 502/242; 502/351; 977/811; 977/896

(57) ABSTRACT

Photocatalytic composite materials, namely materials capable of promoting photo-initiated chemical reactions and processes for producing such materials, are provided. The invention further provides processes for producing photocatalytic composite materials which includes a macroporous matrix, the macroporous matrix having a surface grafting of preformed titanium dioxide nanocrystals, wherein the macroporous matrix may be produced by a sol-gel technique from a precursor of the macroporous matrix in the presence of a template-forming polymer and of hydrophobically-functionalized nano-crystalline titanium-dioxide particles.

### FIELD OF THE INVENTION

The present invention relates to a photocatalytic composite material, namely a material capable of promoting photo-initiated chemical reactions on its surface, as well as to a process for producing it.

### BACKGROUND

In the last few years nanocrystalline titanium dioxide has been extensively studied as the photocatalyst in the oxidative degradation of organic and inorganic pollutants. The interaction of this oxide with UV radiation generates electron-hole pairs which are able to activate surface reactive processes. The recombination rate of charges, which affects catalyst photoactivity, strongly depends on the morphological and structural properties of the oxide, such as the different crystalline phase, surface area, particle shape and porosity. Consequently, the control of the photocatalytic activity of titanium dioxide nanoparticles throughout the tailoring of their morphological and structural properties is a current topic of great interest.

The photodegradation of toxic compounds is usually performed by using titania nanoparticles in aqueous suspension (slurry). However, the use of nanosized powders as slurries in wastewater treatment causes difficult post-use recovery and requires expensive and time-consuming separation/recycling processes. In addition, titanium dioxide nanoparticles, when dispersed in the surrounding environment, may be hazardous, due to their potential inflammatory and cytotoxic effects. These drawbacks can be avoided by immobilizing or embedding the titanium dioxide nanoparticles on a support. Many inorganic or polymeric materials have been employed for this purpose: silica glass beads, rings, reactor walls and fibers; quartz; zeolites; perlite; pumice; alumina-based ceramics; stainless steel; aluminum; cotton fibers; polyester, acrylate, fluorinate polymers. However, both immobilization and embedding frequently lower the exposed area of the catalyst compared to that of the powder suspension.

While polymeric substrates show poor resistance to thermal treatments and undesired sensitivity to photooxidative processes, inorganic membranes consisting of macroporous ceramic substrates covered by micro/meso-porous active titanium dioxide layer—seem promising alternatives for several large scale catalytic processes. In fact, the porous skeleton of the ceramic framework provides chemical and thermal stability, mechanical durability, low pressure drops and rapid mass transport fluids, due to the extensive interconnection between the macropores.

Different approaches, based on soft-chemistry routes, hydrothermal synthesis and chemical (CVD)/physical (PVD) vapour deposition, have been proposed in order to obtain oxide coatings on preformed macroporous ceramic matrices, however these techniques did not give satisfying results.

The ideal active layer should be in fact homogeneous, chemically and thermally stable, loading large amounts of material crucial for the catalytic activity and without pore occlusion which limits the whole permeability. Moreover, the production of these materials should be as easy as possible as well as cost effective. Until the present invention, efforts to achieve all of these goals have failed.

### SUMMARY OF THE INVENTION

Applicants have surprisingly discovered methods for making photocatalytic composite materials having the desired characteristics described above.

An object of the present invention is a process for producing a photocatalytic composite material which is based on a sol-gel synthetic approach and employs hybrid organic-inorganic reactants for the preparation of a porous matrix selected between silica, alumina and zirconia and the simultaneous surface grafting of preformed titanium dioxide nanocrystals.

Another object of the present invention is a titanium dioxide-inorganic macroporous composite material having the following characteristics: a) high macroporosity and UV-transparency of the silica matrix, which guarantee easy accessibility of catalyst surface sites and allows effective interaction of titanium dioxide with UV radiation; b) titanium dioxide nanocrystals grafted on the surface of ceramic matrix, whose well-defined morphological and structural properties provide high photoactivity; c) minimum loss of photoactivity due to catalyst immobilization, in comparison to the slurry TiO₂; and d) improved thermal stability and durability without leaching of the grafted catalyst.

Another object of the present invention is a photocatalytic titanium dioxide-inorganic porous composite material endowed with liquid and gaseous pollutants degradation property and with the property to physically separate the contaminants with self-cleaning action of the membrane.

Another object of the invention is to provide articles, such as filters and filtering means, entirely or partly made with titanium dioxide-inorganic porous composite materials according to embodiments of the invention.

Another object of the invention involves processes for producing a photocatalytic composite material, the processes being based on sol-gel synthetic approaches for the preparation of a porous matrix selected between silica, alumina and zirconia and the simultaneous surface grafting of preformed titanium dioxide nanocrystals, wherein the porosity of the porous matrix may be modulated as a function of the acidity of the sol-gel reaction environment.

Another object of the present invention is a photocatalytic titanium dioxide-inorganic porous composite material having liquid and gaseous pollutant degradation properties and with the property of physically separating contaminants with self-cleaning action of the membrane, wherein the porous composite material is selected from macroporous, mesoporous and microporous composite material.

These objects are achieved by a process and a composite material produced therefrom, as depicted in the annexed claims.

### BRIEF DESCRIPTION OF THE FIGURES

FIG. 1 shows a schematic view of a photoreactor containing representative composite material of the invention in pellet form.

FIG. 2 shows a schematic view of a test system for determining photocatalytic activity of the inventive composite material according to the present invention.

FIG. 3 shows a diagram of phenol degradation kinetics as determined by measuring the total organic carbon (TOC) in solution as a function of time of treatment.

FIG. 4 shows a diagram reporting the t_{1/2} values for the slurry and for TiO₂/silica composite material according to the present invention.

### DETAILED DESCRIPTION

The present invention relates to processes for producing photocatalytic composite material comprising a porous matrix having a surface grafting of preformed titanium dioxide nanocrystals.

Composite material according to embodiments of the invention are produced by a sol-gel technique from a precursor of the porous matrix in the presence of a template-forming polymer and of hydrophobically-functionalized nano-crystalline titanium-dioxide particles.

The porous matrix may be obtained by a sol-gel process based on the transformation of a precursor of the porous matrix. In one embodiment, the precursor of the porous matrix may be a precursor of an inorganic oxide which is transparent to UV radiation and has a band-gap higher than the band-gap of titanium dioxide. Particular examples of such inorganic oxides are silica, alumina and zirconia.

In certain embodiments, the precursor of the porous matrix may be selected from tetra-alkoxydes of silicon, such as tetra-methoxysilane (TMOS) or tetra-ethoxysilane (TEOS), tetra-alkoxydes of alluminium, tetra-alkoxydes of zirconium, alkaline metals silicates, such as sodium silicate Na₂SiO₃, alkaline metals aluminates and alkaline metals zirconates.

In embodiments, the template-forming polymer may be selected from a polyethyleneglycol with a number of monomeric units higher than 100, a polypropyleneglycol and block-copolymers polyethyleneglycol/polypropyleneglycol.

In certain embodiments, titanium dioxide may be in its anatase form. Nanocrystalline titanium dioxide anatase may be prepared, for example, by a hydrothermal synthesis process, as described below. Other conventional methods also may be used.

In another embodiment, hydrophobically-functionalized nanocrystalline titanium dioxide particles may be selected from nanocrystalline titanium dioxide particles functionalized with an organic molecule selected from primary alkylamines, primary alkoxyalkylamines, aliphatic-chain carboxylic acids, alkoxyaliphatic-chain carboxylic acids, aliphatic-chain phosphonates and alkoxyaliphatic-chain phosphonates. Specific examples of such organic molecules include propionic acid, hexylamine and 2-methoxyethylamine.

Processes according to the present invention may include the following steps:

1) providing nanocrystalline titanium dioxide particles;
2) functionalizing the nanocrystalline titanium dioxide particles of step 1) in solution with organic molecules conferring hydrophobic properties to the titanium dioxide surface and isolating hydrophobically-functionalized titanium dioxide particles;
3) providing an acidic solution containing a template-forming polymer;
4) adding to the acidic solution of the template-forming polymer of step 3) the hydrophobically-functionalized nanocrystalline titanium dioxide particles obtained at step 2) and a precursor of a porous matrix;
5) forming a composite material intermediate from the solution of step 4);
6) treating the composite material intermediate of step 5) at a temperature between about room temperature and about 100° C. for a period of time sufficient to form a gel;
7) drying the gel obtained at step 6);
8) annealing the dried gel obtained at step 7) to provide the final porous composite material.

The hydrophobically-functionalized nanocrystalline titanium dioxide particles are highly dispersible in the polymer phase and, at the same time, facilitate their interaction with polymer, onto the pores of the ceramic matrix, avoiding their embedding into the matrix.

In certain embodiments nanocrystalline titanium dioxide particles solution of step 2) may be an alcohol solution such as an organic solution, for example, ethyl acetate, and is generally able to dissolve the functionalizing molecules and to disperse the titanium dioxide crystals.

In certain embodiments the acidic solution of step 3) may be an acidic solution containing acetic acid, propionic acid or inorganic acids such as hydrochloric, nitric or sulphuric acid.

Step 5) may be performed, for example, by moulding in a suitable mould or by coating a surface of a preformed article. For example, the composite material intermediate may be formed into pellets or monolithic articles of larger dimension.

In certain embodiments, gel-forming step 6) may be performed at a temperature up to about 80° C. and for a time ranging from about 24 to about 48 h.

In certain embodiments, drying step 7) may be performed at a temperature ranging from about 120° C. to about 150° C., preferably for a time ranging from about 24 to about 48 h.

In certain embodiments, annealing step 8) may be performed at a temperature ranging from about 500° C. to about 900° C., preferably for a time ranging from about 3 to about 10 hours.

The composite material obtained from the above processes may be characterized by high porosity of the porous matrix, which allows high permeability to liquid and gaseous fluids, and by homogeneous dispersion of the titanium dioxide nanocrystals on the surface of the pores, which confers high photoactivity in oxidative degradation reactions of various organic and inorganic molecules.

In certain embodiments the porosity percentage of the porous matrix of the composite material may be more than about 70% of the total volume.

In certain embodiments the titanium dioxide layer may be mesoporous, with an average diameter of the pores between about 3.0 and about 4.5 nm or, in particular embodiments, about 3.6 nm.

The average size of the porous matrix particles may be between about 2 and about 3 μm.

As a result of these features, the composite material of the invention may be used to manufacture photocatalytic membranes coupling the activity of degradation of organic and inorganic pollutants in liquid and gaseous phase and allows for the physical separation of the contaminants by the self-cleaning action of the membrane.

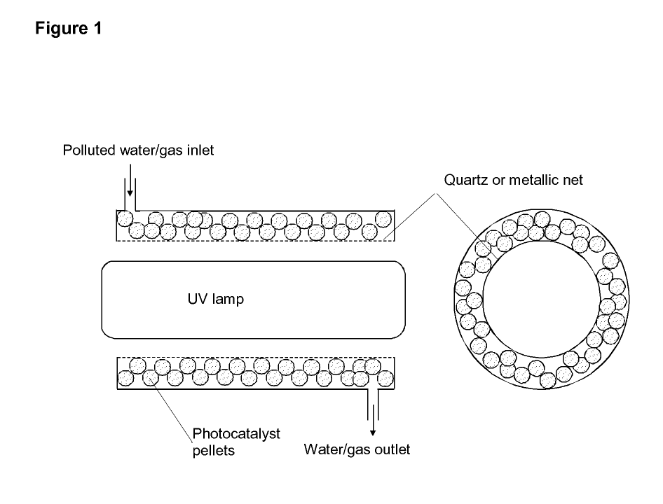

Embodiments of the present invention are particularly useful in photoreactors designed to allow purifying fluids to pass through composite material under UV irradiation. An example of a photoreactor containing composite material according to embodiments of the present invention in the form of pellets is schematically shown in FIG. 1.

Advantageously, the composite material of the present invention may have nanocrystalline titanium dioxide particles immobilized on its surface without loss of photoactivity and without releasing nano-powders into environment. Moreover, expensive processes of filtering purified fluid to separate the photoactive titanium dioxide may be avoided, as is required conversely when conventional photocatalytic titanium dioxide slurries are used.

Composite material according to the present invention may be used in systems for purifying and eliminating bacteria from gaseous fluids in indoor atmosphere, civil and industrial environments, in association with apparatuses for air conditioning and filtering particulate materials in the atmosphere, or from liquid fluids in civil and industrial waste-water.

In certain embodiments, the present invention provides processes for producing photocatalytic porous composite materials, such processes being based on a sol-gel synthetic approach for the preparation of a porous matrix selected from silica, alumina and zirconia and the simultaneous surface grafting of preformed titanium dioxide nanocrystals, wherein the porosity of the porous matrix may be modulated as a function of the acidity of the sol-gel reaction environment.

The porosity of the hosting matrix i.e. the dimension of the pores, may be varied by changing the nature and/or the concentration of the acids used in the sol-gel reaction.

As shown in Table I below, carboxylic acids may be used to produce a macroporous matrix while mineral acids may be used to produce a meso/microporous matrix.

In the range of concentrations shown in Table I, by increasing the acid concentration, (thus lowering the pH) larger pores may be obtained. In this way the mechanical and filtration properties of the material may be adapted to a wide variety of applications.

TABLE I

| Acetic Acid | | HCl | |
|---|---|---|---|
| | Average | | Average |
| Concentration | pore radius | Concentration | pore radius |
| [M] | [μm] | [M] | [μm] |
| 0.10 | 0.5-0.7 | 1.34 10⁻³ | 0.002-0.003 |
| 0.25 | 1.0 | 2.11 10⁻³ | 0.005 |
| 0.50 | 2.4 | 2.99 10⁻³ | 0.01 |

In certain embodiments of the invention, processes are provided as described above, wherein step 3) (providing an acidic solution) may include adding carboxylic acid to acidify the solution in a concentration in the range of between about 0.05 M and about 0.60 M, preferably of between about 0.10 M and about 0.50 M, wherein the final porous composite material is a macroporous composite material.

In such embodiments, the macroporous composite material may be characterized by having at least about 60% of pores with an average radius of between about 0.5 and about 2.5 μm or, in one embodiment, between about 0.5 and about 1.5 μm or, in still further embodiments, between about 0.8 and about 1.2 μm.

In another embodiment of the invention, processes provided as described above, wherein step 3) (providing an acidic solution) may include adding an inorganic acid to acidify the solution in a concentration in the range of between about 1.0×10⁻³ M and about 4.0×10⁻³ M, preferably of between about 1.3×10⁻³ M and about 3.3×10⁻³ M, wherein the final porous composite material may be a microporous or mesoporous composite material, the microporous composite material being obtained by the lower pH of the solution.

In such embodiments, the micro- or meso-porous composite material may be characterized by having at least about 60% of pores with an average radius of between about 0.0015 and about 0.015 μm or, in further embodiments, between about 0.002 and about 0.010 μm.

### EXAMPLES

### Example 1

### Functionalization of Titanium Dioxide Nanoparticles

Nanocrystalline titanium dioxide anatase was obtained by hydrothermal synthesis according to a known procedure, by reacting aqueous solutions of TiOCl₂ (Aldrich, 99%) and NH₃ (Fluka, >25 wt %) in a Teflon lined autoclave (Parr, model 4768Q). The autoclave was heated at a rate of 2.67° C./min to 30° C. below the set-point temperature, then at a rate of 0.75° C./min up to 220° C. TiO₂ surface was functionalized as follows: in anhydrous conditions, 20 mL of the organic reagent (propionic acid, PA; or hexylamine, HA; or 2-methoxyethylamine, MA) was added to 3.30 g of TiO₂ anatase suspended, after ultrasound treatment, in 40 mL of anhydrous methanol. The amount of the organic reagents was in large excess compared to the oxide. The obtained suspension was refluxed for 8 hr and kept overnight under stirring at room temperature. Finally, the particles were separated by centrifugation at 6000 rpm for 30 minutes and recovered by decantation. In order to remove the unreacted chemicals and the residual traces of methanol, the particles were washed for 30 minutes under ultrasound conditions with ethyl acetate (2×10 mL) and methylene chloride (2×10 mL). After each washing, the surnatant was separated by centrifugation and decantation. The final wet powder was dried in air at room temperature and the residual solvent evaporated 24 hr in vacuum (10⁻² Torr).

### Example 2

### Preparation of TiO₂/SiO₂ Composite Material (TS)

0.723 g of PEG 20000 were dissolved in 6.90 mL of a solution of acetic acid 0.10 M. After complete dissolution of the polymer, 150 mg of nanocrystalline titanium dioxide particles, functionalized with 2-methoxyethylamine as described above—corresponding to a 10.7 wt % nominal content in the final composite material—were added to the solution and are uniformly dispersed by ultrasound treatment. Subsequently, 3.10 mL of tetra-methoxysilane were added under stirring. The solution was put in a Teflon mould having cylindrical cavities of 1 cm diameter and 1 cm height. The mould was closed and was placed in an oven at 100° C. for 24 hr and, subsequently, at 80° C. for further 24 hr.

The sample was then calcined in air at 500° C. in for a time sufficient to eliminate by combustion the organic/inorganic precursors residues (hydrophobically-functionalizing organic molecules, template-forming polymer and residue of the acids) (about 5 hours). A material in the form of pellets was obtained.

The silica matrix so obtained has a macroporous structure. The overall porosity, measured with a Hg porosimeter (Pascal 140/240 Thermo Fisher instrument), assuming 140° as contact angle between mercury and sample and in a pressure range varied between 15.8 kPa and 200 MPa, is 75±5% of the total volume, 60% of macropores having an average radius of between 0.8 and 1.2 μm. The nanocrystalline titanium dioxide particles do not modify their crystalline phase, as determined by X Ray Diffraction technique (Brucker D8 Advance, Cu K_{α} radiation) in the range 20-60° 20 (20 step 0.025°, count time of 2 s per step).

By TEM (Transmission Electron Microscopy) analysis it was also determined that the titanium dioxide particles are evenly distributed on the surface of the pores in the silica matrix.

Nitrogen absorption (BET) measures indicate that the titanium dioxide layer is mesoporous, with an average diameter of the pores of about 3.6 nm.

### Example 3

### Photocatalytic Test

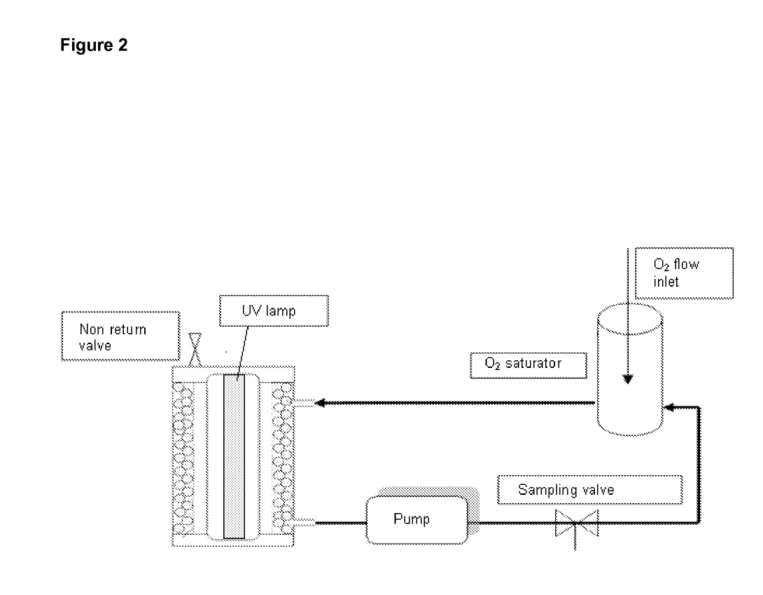

The TiO₂/silica composite material prepared according to the above procedures was tested in reactions of oxidative degradation of phenol in solution. The system used for the test is schematically shown in FIG. 2.

The recirculation plant was endowed with a photoreactor of the type shown in FIG. 1 with a housing for catalyst pellets, a UV lamp coaxial to the reactor, a saturator for oxidizing the solution and a peristaltic pump for recirculating the solution. The operative conditions were as follows: 600 mL aqueous solution of phenol (120 ppm); 11.0 g of pellets of TiO₂/silica composite material; oxygen saturated solution; recirculation rate 14 mLs⁻¹; temperature 25° C. The UV lamp was switched on after 1 hour of recirculation in dark.

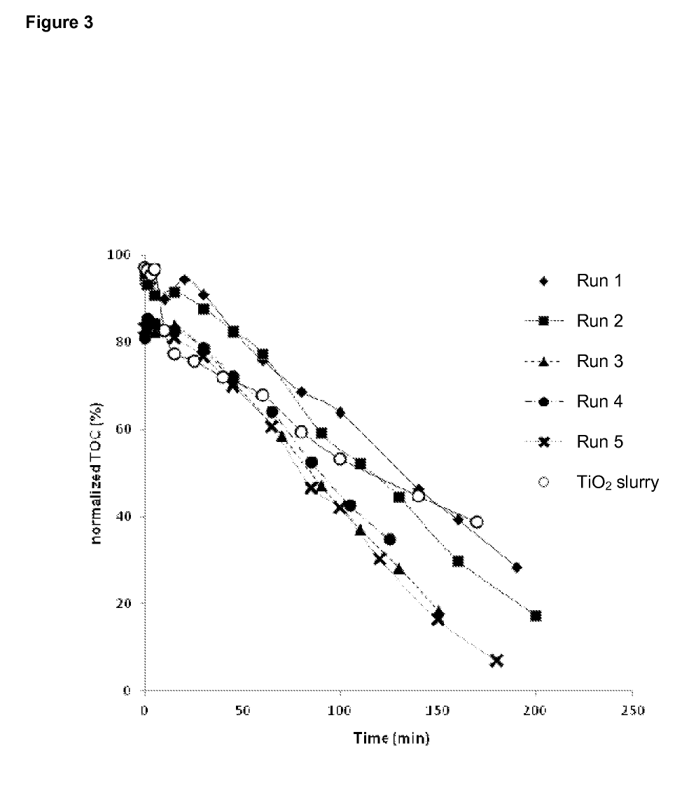

Phenol degradation kinetics were determined by measuring the total organic carbon (TOC) in solution (FIG. 3). The catalyst performance was evaluated by calculating the half degradation time t_{1/2}, i.e. the time necessary to halve the TOC concentration in solution.

The results obtained with the TiO₂/silica composite material described above were compared with those obtained with the same TiO₂ catalyst not immobilized and dispersed as a slurry in aqueous solution, which were submitted to the same reaction conditions (amount of catalyst, illumination, recirculation rate).

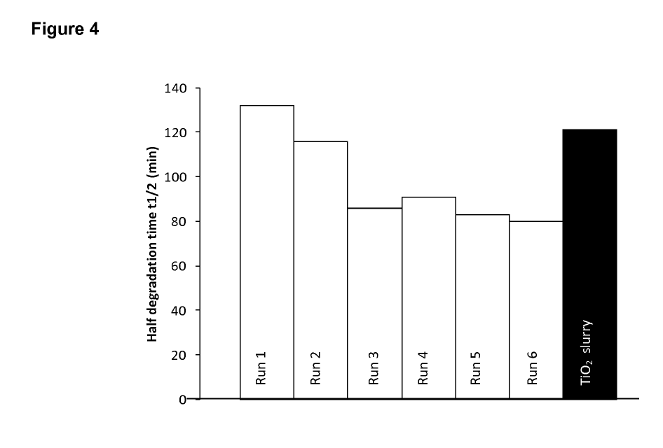

FIG. 4 shows the t_{1/2} values for the slurry and for the TiO₂/silica composite material of the invention, this latter being subject to various recirculation cycles (cycles 1 to 6). Cycle 1 shows a performance similar to that of the TiO₂ slurry (120-130 min), while subsequent cycles show a constant increase of performance up to a plateau at cycle 3 with a t_{1/2}=80 min. In fact, the catalysts generally require an activation period in order to clean the active surface from the reaction residues. The stabilization of the t_{1/2} value further proves that the inventive processes composite material is not affected by catalyst loss during use.

1. A method for producing a photocatalytic composite material comprising,
providing nano-crystalline titanium dioxide particles,
functionalizing the nano-crystalline titanium dioxide particles in a solution comprising organic molecules, the organic molecules comprising hydrophobic chains,
providing a solution comprising a template-forming polymer, and
adding to the solution comprising the template-forming polymer the functionalized titanium dioxide particles and a precursor of a porous matrix.

2. The method of claim 1, wherein the precursor of the porous matrix is a precursor of an inorganic oxide which is transparent to UV radiation and which has a band-gap higher than the band-gap of titanium dioxide.

3. The method of claim 2, wherein the inorganic oxide is selected from the group consisting of: silica, alumina and zirconia.

4. The method of claim 1, wherein the precursor of the porous matrix is selected from the group consisting of: tetra-alkoxydes of silicon, tetra-alkoxydes of alluminium, tetra-alkoxydes of zirconium, alkaline metals silicates, alkaline metals aluminates and alkaline metals zirconates.

5. The method of claim 1, wherein the precursor of the porous matrix is selected from the group consisting of tetra-methoxysilane (TMOS), tetra-ethoxysilane (TEOS) and sodium silicate Na₂SiO₃.

6. The method of claim 1, wherein the template-forming polymer is selected from the group consisting of: polyethyleneglycol with a number of monomeric units higher than 100, a polypropyleneglycol and block-copolymers polyethyleneglycol/polypropyleneglycol.

7. The method of claim 1, wherein the titanium dioxide particles comprise its anatase form.

8. The method of claim 1, wherein the titanium dioxide particles are functionalized with an organic molecule selected from the group consisting of: primary alkylamines, primary alkoxyalkylamines, aliphatic-chain carboxylic acids, alkoxyaliphatic-chain carboxylic acids, aliphatic-chain phosphonates and alkoxyaliphatic-chain phosphonates.

9. The method of claim 8, wherein the organic molecule is selected from the group consisting of hexylamine and 2-methoxyethylamine.

10. A method for producing a photocatalytic composite material, comprising the following steps:
1) providing nanocrystalline titanium dioxide particles;
2) functionalizing the nanocrystalline titanium dioxide particles of step 1) in solution with an organic molecule conferring hydrophobic properties to the titanium dioxide surface and isolating hydrophobically-functionalized titanium dioxide particles;
3) providing an acidic solution containing a template-forming polymer;
4) adding to the acidic solution of the template-forming polymer of step 3) the hydrophobically-functionalized nanocrystalline titanium dioxide particles obtained at step 2) and a precursor of the porous matrix;
5) forming from the solution of step 4) a composite material intermediate;
6) treating the composite material intermediate of step 5) at a temperature between about room temperature and about 100° C. for a period of time sufficient to form a gel;
7) drying the gel obtained at step 6);
8) annealing the dried gel obtained at step 7) to provide the final photocatalytic composite material.

11. The method of claim 10, wherein the nanocrystalline titanium dioxide particles solution of step 2) is an alcohol solution.

12. The method of claim 10, wherein the acidic solution of step 3) is an acidic solution of a carboxylic acid.

13. The method of claim 12, wherein the carboxylic acid is selected from the group consisting of: acetic acid and propionic acid.

14. The method of claim 10, wherein the acidic solution of step 3) is an acidic solution of an inorganic acid.

15. The method of claim 14, wherein the inorganic acid is selected from the group consisting of hydrochloric acid, nitric acid and sulphuric acid.

16. The method of claim 10, wherein the formation of the composite material intermediate of step 5) comprises the step 5) moulding in a suitable mould or coating a surface of a preformed article.

17. The method of claim 10, wherein the gel-forming step 6) is performed at a temperature up to about 80° C. and for a time ranging from about 24 to about 48 h.

18. The method of claim 10, wherein the drying step 7) is performed at a temperature ranging from about 120° C. to about 150° C.

19. The method of claim 18, wherein the drying step 7) is performed for a time ranging from about 24 to about 48 h.

20. The method of claim 10, wherein the annealing step 8) is performed at a temperature ranging from about 500° C. to about 900° C.

21. The method of claim 20, wherein the annealing step 8) is performed for a time ranging from about 3 to about 10 hours.

22. The method of claim 10, wherein step 3) comprises adding a carboxylic acid to acidify the solution in a concentration from about 0.05 M to about 0.60 M.

23. The method of claim 22, wherein the carboxylic acid concentration is from about 0.10 M to about 0.50 M.

24. The method of claim 22, wherein the carboxylic acid is selected from the group consisting of: acetic acid and propionic acid.

25. The method of claim 10, wherein step 3) comprises adding an inorganic acid to acidify the solution in a concentration from about 1.0×10⁻³ M and to about 4.0×10⁻³ M.

26. The method of claim 25, wherein the inorganic acid is in a concentration from about 1.3×10⁻³ M to about 3.3×10⁻³ M.

27. The method of claim 25, wherein the inorganic acid is selected from the group consisting of: hydrochloric acid, nitric acid and sulphuric acid.

28. A photocatalytic composite material comprising a porous matrix, the porous matrix having a surface grafting of preformed titanium dioxide nanocrystals, wherein the porous matrix is an inorganic oxide which is transparent to UV radiation and which has a band-gap higher than the band-gap of titanium dioxide.

29. The photocatalytic composite material of claim 28, wherein the inorganic oxide is selected from silica, alumina and zirconia.

30. The photocatalytic composite material of claim 28, wherein the titanium dioxide is in its anatase form.

31. The photocatalytic composite material of claim 28, wherein the porous matrix is macroporous and wherein the porosity percentage of the macroporous matrix is more than about 70% of the total volume, and wherein at least about 60% of the macropores have an average radius of between about 0.5 and about 2.5 μm.

32. The photocatalytic composite material of claim 31, wherein at least about 60% of the macropores have an average radius of between about 0.5 and about 1.5 μm.

33. The photocatalytic composite material of claim 31, wherein at least about 60% of the macropores have an average radius of between about 0.8 and about 1.2 μm.

34. The photocatalytic composite material of claim 28, wherein the porous matrix may be microporous and/or mesoporous, wherein the porosity percentage of the matrix is more than about 70% of the total volume, and wherein at least about 60% of pores have an average radius of between about 0.0015 and about 0.015 μm.

35. The photocatalytic composite material of claim 34, wherein at least about 60% of the pores have an average radius of between about 0.002 and about 0.010 μm.

36. The photocatalytic composite material of claim 28, wherein the titanium dioxide is mesoporous, with an average diameter of the pores of between about 3.0 and 4.5 nm.

37. The photocatalytic composite material of claim 36, wherein the titanium dioxide has an average diameter of the pores of about 3.6 nm.

38. The photocatalytic composite material of claim 28, wherein the porous matrix comprises particles having an average size of between about 2 and about 3 μm.

39. A photoreactor comprising the photocatalytic composite material of claim 28, said photoreactor adapted for allowing fluid to pass through the composite material under UV irradiation wherein said fluid is thereby purified.

40. The photoreactor of claim 39, wherein the photocatalytic composite material comprises pellets.
